(19) United States
(12) Patent Application Publication
(10) Pub. No.: US 2005/0013987 A1
(43) Pub. Date: Jan. 20, 2005

(54) Foam-layered dressing, a method for making the same, a method for applying a dressing, a foam composition, and a foam layer composition produced by a process

(76) Inventors: Roy Carr, Burr Ridge, IL (US); George Worthley, Wheaton, IL (US)

Correspondence Address: PATENTS+TMS;A Professional Corporation, 1914 North Milwaukee Avenue, Chicago, IL, 60647, US

(21) Appl. No.: 10/881,287

(22) Filed: Jun. 30, 2004

Related U.S. Application Data
(60) Provisional application No. 60/487,666, filed on Jul. 16, 2003.

(51) Int. Cl. B32B 3/02; D04H 11/00; D05C 17/00; D03D 27/00; B32B 33/00; B05D 5/12; B32B 5/14; B32B 3/26; B32B 3/00

(52) U.S. Cl. 428/304.4; 427/119; 428/316.6; 428/310.5

(57) ABSTRACT

A foam-layered dressing, a method for making the same, a method for applying the same, a foam composition, and a foam layer composition produced by a process are provided. The dressing may have two or more foam layers. To this end, a slurry may be added to a first foam layer. The slurry and the first foam layer may be cured and dried. As a result, the slurry may undergo a chemical change and may form a second foam layer. The first foam layer and the second foam layer may be separated by an interface. The foam layers and the interface layer may have a moisture/vapor transmission rate which may assist in healing a specific type of wound.

This application claims the benefit of U.S. Provisional Application Ser. No. 60/487,666, filed Jul. 16, 2003.

### BACKGROUND OF THE INVENTION

The present invention generally relates to a dressing constructed from foam layers, a method for making the same, a method for applying the same, a foam composition, and a foam layer composition produced by a process. More specifically, the present invention relates to a dressing which may be formed by adding a slurry to a first foam layer. The slurry may be cured and may form a second foam layer. An interface layer may be formed by adhesion of the first foam layer to the second foam layer. The interface layer may provide, for example, a moisture/vapor transmission rate to the dressing which may be necessary to healing of a specific type of wound.

It is, of course, generally known to use dressings for treatment and/or covering of wounds. Such dressings are generally in the form of a sheet of film, foam, fabric or combination thereof. Various layers of a dressing must be bonded via, for example, addition of adhesive layers or excessive heating of the layers to cause the layers to bond. Use of an adhesive layer causes an overall cost of the dressing to increase. Heating the layers requires additional equipment costs.

Wounds require a number of conditions to properly heal. A first condition is a sterile environment in which to heal, namely, a sterile area between the wound and the dressing. Another condition is absorption of bodily fluids from the wound. A third factor is a favorable moisture/vapor transmission rate between the wound and the dressing. A variance for each of these factors is based on the type of wound requiring treatment.

However, known dressings are constructed with a fixed number of properties. More specifically, each known dressings merely supplies a fixed amount of sterility to a wound, independent of the type of wound. Further, known dressings merely supply a fixed amount of absorption, or a fixed amount of moisture/vapor transmission, independent of the type of wound. As a result, the wound receives proper treatment with respect to certain properties but does not receive adequate treatment in all required aspects.

In addition, known dressings are constructed wherein a single surface contacts a wound to assist in healing of the wound. Accordingly, the dressing must be applied in a specific manner to achieve healing of the wound wherein a first surface contacts and treats the wound. A second surface, opposite the first surface, is not suitable for treating the wound and does not contact the wound. Thus, a new dressing is required when the first surface is no longer fresh, i.e., no longer providing adequate treatment to the wound. Removal and replacement of dressings is a time-consuming and costly process.

A need, therefore, exists for a foam-layered dressing, a method for making the same, a method for applying the same, a foam composition, and a foam layer composition produced by a process wherein the dressing may be constructed to provide properties necessary to healing a specific type of wound.

### SUMMARY OF THE INVENTION

The present invention generally relates to a foam-layered dressing, a method for making the same, a method for applying the same, a foam composition, and a foam layer composition produced by a process. The dressing may have two or more foam layers formed from adding a slurry on a first foam layer. A second foam layer, formed from curing of the slurry, may adhere to the first foam layer. The second foam layer and the first foam layer may be separated by an interface layer. The foam layers and the interface layer may be configured to provide properties, such as, for example, a desired moisture/vapor transmission rate required to treat a specific type of wound.

To this end, in an embodiment of the present invention, a dressing is provided which is prepared by a process comprising the steps of: providing a first foam layer; adding a slurry over the first foam layer wherein the slurry comprises a surfactant, an absorbent, a plasticizer and an active agent; curing the slurry and the first foam layer; and drying the slurry and the first foam layer until the slurry forms a second foam layer which attaches to the first foam layer.

In an embodiment, the foam layered dressing has an interface between the first foam layer and the second foam layer.

In an embodiment, the first foam layer is comprised of a surfactant, an absorbent, a plasticizer and an active agent wherein each is identical to the surfactant, the absorbent, the plasticizer and the active agent of the slurry.

In an embodiment, the first foam layer is comprised of a surfactant, an absorbent, a plasticizer and an active agent wherein at least one of the surfactant, the absorbent, the plasticizer and the active agent of the first foam layer is different from the surfactant, the absorbent, the plasticizer and the active agent of the slurry.

In an embodiment, the slurry has a prepolymer.

In an embodiment, the slurry has a saline solution.

In another embodiment of the present invention, a foam layer composition is provided which is produced by a process comprising the steps of: providing a first slurry comprising a surfactant, an absorbent, a plasticizer and an active agent; curing the first slurry until the first slurry forms a first foam layer; adding a second slurry over the first foam layer wherein the slurry comprises a surfactant, an absorbent, a plasticizer and an active agent; curing the second slurry and the first foam layer; and drying the second slurry and the first foam layer until the second slurry forms a second foam layer is formed wherein the second foam layer bonds with the first foam layer.

In an embodiment, the first foam layer and the second foam layer have different rates of moisture/vapor transmission.

In an embodiment, at least one of the surfactant, the absorbent, the plasticizer and the active agent of the first foam layer is different from the surfactant, the absorbent, the plasticizer and the active agent of the second slurry.

In an embodiment, the foam layer composition has an interface formed between the first foam layer and the second foam layer.

In an embodiment, the foam layer composition has a third slurry contacting the second foam layer wherein the third slurry is comprised of a surfactant, an absorbent, a plasticizer and an active agent.

In another embodiment of the present invention, a foam-layered dressing is provided which is prepared by a process comprising the steps of: providing a first foam layer having a first moisture/vapor transmission rate; adding a slurry over the first foam layer wherein the slurry comprises a surfactant, an absorbent, a plasticizer, an active agent and a prepolymer; curing the slurry and the first foam layer; and drying the slurry and the first foam layer until the slurry forms a second foam layer wherein the second foam layer has a second moisture/vapor transmission rate which is different from the first moisture/vapor transmission rate and further wherein an interface is formed between the first foam layer and the second foam layer wherein the interface has a third moisture/vapor transmission rate which is not equal to the first moisture/vapor transmission rate and the second moisture/vapor transmission rate.

In an embodiment, the first foam layer is thicker than the second foam layer.

In an embodiment, the first foam layer is hydrophilic.

In an embodiment, the second foam layer is hydrophobic.

In an embodiment, the first foam layer is comprised of a surfactant, an absorbent, a plasticizer and an active agent wherein each is identical to the surfactant, the absorbent, the plasticizer and the active agent of the slurry.

In another embodiment of the present invention, a method is provided for making a dressing, the method comprising the steps of: providing a first foam layer; adding a slurry onto the first foam layer wherein the slurry comprises a surfactant, an absorbent, a plasticizer, and an active agent; and curing the slurry and the first foam layer wherein the slurry forms a second foam layer and further wherein the second foam layer secures to the first foam layer.

In an embodiment, the method has the further step of drying the second foam layer and the first foam layer.

In an embodiment, the method has the further step of trimming the first foam layer and the second foam layer.

In an embodiment, the method has the further step of mixing a prepolymer into the slurry prior to pouring the slurry onto the first foam layer.

In an embodiment, the method has the further step of pouring a second slurry onto the second foam layer.

In another embodiment of the present invention, a foam composition is provided. The foam composition has a surfactant in a percentage weight range from 0.1 to 20%. The foam composition also has an absorbent in a percentage weight range from 0.1 to 20%. In addition, the foam composition has a plasticizer in a percentage weight range from 0.1 to 20%. Further, the foam composition has an active agent in a percentage weight range from 0.01 to 10%. A prepolymer is provided in a percentage weight range from 30 to 70%.

In an embodiment, the surfactant is selected from a group consisting of pluronic surfactant, F108, F88 and F68LF, or other non-ionic block surfactants.

In an embodiment, the prepolymer is selected from a group consisting of TDI, MDI, IPDI, or other diisocyanates. Other substrate foam layers may be polyvinyl chloride, polyvinyl alcohol, polyethylene and/or any other plastic foams.

In an embodiment, the plasticizer is selected from a group consisting of glycerin, propylene glycol, and castor oil.

In an embodiment, the active agent is selected from a group consisting of white gold, silver, tea tree oil, zinc gluconate, tumeric, bromelain, lavendar, gotu kola, sodium hyaluronate, emu oil, aloe or other wound healing substances.

In another embodiment of the present invention, a method is provided for applying a dressing. The method has the steps of: providing a first foam layer comprising a surfactant, an absorbent, a plasticizer and an active agent wherein the first foam layer has a top surface and a bottom surface; and securing a second foam layer to the first foam layer wherein the second foam layer comprises a surfactant, an absorbent, a plasticizer and an active agent and wherein a top surface of the second foam layer contacts a bottom surface of the first foam layer wherein either the top surface of the first foam layer or bottom surface of the second foam layer is capable of providing treatment to the wound wherein the wound undergoes a healing process when the top surface or the bottom surface contacts the wound.

In an embodiment, the method has the further step of contacting the wound with the top surface of the first foam layer.

In an embodiment, the method has the further step of contacting the wound with the bottom surface of the second foam layer.

In another embodiment of the present invention, a method is provided for making a dressing. The method has the steps of: providing a first foam layer having a film layer attached to the first foam layer; adding a slurry onto the first foam layer wherein the slurry comprises a surfactant, an absorbent, a plasticizer, and an active agent; and curing the slurry and the first foam layer wherein the slurry forms a second foam layer and further wherein the second foam layer secures to the first foam layer.

In an embodiment, the method has the further step of: drying the second foam layer and the first foam layer.

In an embodiment, the method has the further step of trimming the first foam layer and the second foam layer.

In an embodiment, the film layer is constructed from a copolymer film.

In an embodiment, the first foam layer is hydrophobic.

It is, therefore, an advantage of the present invention to provide a foam-layered dressing, a method for making the same, a method for applying the same, a foam composition, and a foam layer composition produced by a process wherein the dressing may provide a sterile environment for a wound.

Another advantage of the present invention is to provide a foam-layered dressing, a method for making the same, a method for applying the same, a foam composition, and a foam layer composition produced by a process wherein the dressing may provide a moisture/vapor transmission rate which may be beneficial to healing of a wound.

Still another advantage of the present invention is to provide a foam-layered dressing, a method for making the same, a method for applying the same, a foam composition, and a foam layer composition produced by a process wherein the dressing may absorb bodily fluids excreted from a wound.

Yet another advantage of the present invention is to provide a foam-layered dressing, a method for making the same, a method for applying the same, a foam composition, and a foam layer composition produced by a process wherein the dressing may be constructed to have medicinal properties which may correspond to a type of wound requiring treatment.

And, another advantage of the present invention is to provide a foam-layered dressing, a method for making the same, a method for applying the same, a foam composition, and a foam layer composition produced by a process wherein the dressing may be inexpensive to manufacture.

Additional features and advantages of the present invention are described in, and will be apparent from, the detailed description of the presently preferred embodiments and from the drawings.

### BRIEF DESCRIPTION OF THE DRAWINGS

FIG. 1 illustrates a cross-sectional view of a dressing in an embodiment of the present invention.

FIG. 2 illustrates a cross-sectional view of a dressing having layers of varying thickness in an embodiment of the present invention.

FIG. 3 illustrates a method for forming a foam layer in an embodiment of the present invention.

### DETAILED DESCRIPTION OF THE PRESENTLY PREFERRED EMBODIMENTS

The present invention generally relates to a foam-layered dressing, a method for making the same, a method for applying the same, a foam layer composition, and a foam layer composition produced by a process. The dressing may have two or more foam layers. To this end, a slurry may be added to a first foam layer. The slurry and the first foam layer may be cured and dried. As a result, the slurry may form a second foam layer. The first foam layer and the second foam layer may be separated by an interface layer which may form during the curing process and/or the drying process. The foam layers and the interface layer may be configured to provide a moisture/vapor transmission rate which may be necessary for healing of a specific type of wound.

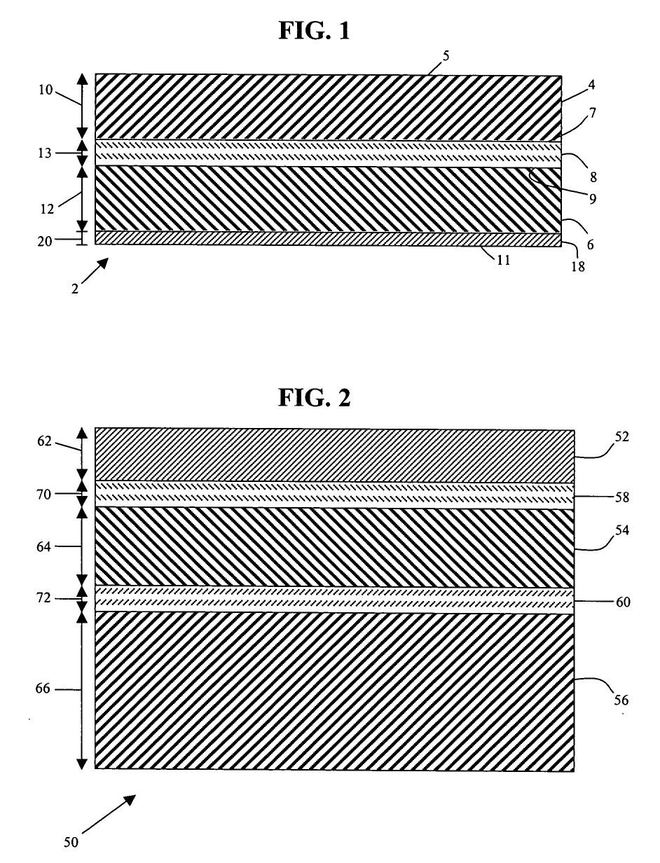

Referring now to the figures wherein like numerals refer to like parts, FIG. 1 illustrates a dressing 2 having a foam layer 4, or substrate layer, which may be attached to a foam layer 6, or contact layer. The foam layer 4 and/or the foam layer 6 may be comprised of the following components: a surfactant, an absorbent, a plasticizer, an active agent, water or saline, and a prepolymer. Ranges for each of these components are provided below in Table 1:

TABLE 1

| Component | Range |
|---|---|
| Surfactant | 0.1 to 20% |
| Polyurethane prepolymer | 30 to 70% |
| Absorbent | 0.1 to 20% |
| Plasticizer | 0.1 to 20% |
| Active agent | 0.01 to 10% |
| Water or normal saline | 10 to 50% |

The surfactant may be, for example, pluronic surfactant F108, F88, or F68LF. The polyurethane prepolymer may be, for example, TDI, MDI, IPDI. Other foam or film layers which serve as substrates may be polyvinyl chloride, polyvinyl alcohol, polyethylene and/or any other plastic foams. The absorbent may be calcium alginate (or carboxy methyl cellulose). The plasticizer may be, for example, glycerin, propylene glycol, or castor oil. The active agent may be white gold, silver, tea tree oil, zinc gluconate, tumeric, bromelain, lavendar, gotu kola, sodium hyaluronate, emu oil, aloe, or other wound healing substances. Water, saline, or Ringer's solution may also be implemented within the foam layer 4 and/or the foam layer 6.

In another embodiment, the foam layer 4 and/or the foam layer 6 may have, for example, interactive polymers, skin agents, antimicrobials, fillers and/or absorbing agents or the like. The foam layer 4 and/or the foam layer 6 may be hydrophobic or hydrophilic. In an embodiment, the foam layer 4 and the foam layer 6 may be constructed from the same components in the same percentage weights.

The foam layer 4 may have a top surface 5 and a bottom surface 7. The foam layer 6 may have a top surface 9 and a bottom surface 11. In addition, the foam layer 4 may have a thickness 10 and the foam layer 6 may have a thickness 12. In an embodiment, the thickness 10 may be equal to the thickness 12. In another embodiment, the thickness 10 and the thickness 12 may be different. The foam layer 4 and the foam layer 6 may have a thickness 10, 12, respectively, in a range of, for example, 0.001 inches to 1.0 inch. In a preferred embodiment, the thickness 10 may be 0.15-0.20 inches, and the thickness 12 may be 0.05-0.10 inches. The thickness 10 of the foam layer 4 or the thickness 12 of the foam layer 6 may be dependent on desired properties for the dressing 2, such as, for example, wound healing, absorption of body fluids, prevention of infection, and control of a moisture vapor transmission rate.

In an embodiment, the foam layer 6 may be hydrophobic. A film layer 18 may be attached to the bottom surface 11. The film layer 18 may be constructed from, for example, polyurethane film, copolymer film, or other plastic films. The film layer 18 may have a thickness 20 in a range of 0.0005 inches to 0.005 inches. In an embodiment, the film layer 18 may be attached to the foam layer 6 prior to attachment of the foam layer 4 to the foam layer 6.

An interface layer 8 may be between the foam layer 4 and the foam layer 8. The interface layer 8 may be formed from adhesion of the foam layer 6 to the foam layer 4. Adhesion may occur via a process (described in further detail below) in which the foam layer 6, in the form of a slurry, is added or poured onto the foam layer 4. The slurry and the foam layer 4 are cured, thereby causing the slurry to undergo a chemical change and form the foam layer 6. The foam layer 4 and the foam layer 6 may then be bonded. The foam layer 4 may have a first moisture/vapor transmission rate. The foam layer 6 may have a second moisture/vapor transmission rate. The first moisture/vapor transmission rate and the second moisture/vapor transmission rate may or may not be equal. Because of the adhesion between the foam layer 4 and the foam layer 6, the interface layer 8 may have a third moisture/vapor transmission rate which may be different from the first moisture/vapor transmission rate and the second moisture/vapor transmission rate. A factor which may affect the moisture/vapor transmission rate for the interface layer 8 may be, for example, a chemical composition of the foam layer 4 and/or the foam layer 6 due to an effect on hydrophilicity of the dressing 2.

FIG. 2 illustrates a dressing 50 which may have a foam layer 52. A foam layer 54 may contact the foam layer 52. A foam layer 56 may contact the foam layer 54. The foam layers 52, 54, 56 may be constructed from components similar to the those used to construct the foam layers 4, 6. The foam layer 52 may have a thickness 62; the foam layer 54 may have a thickness 64; and the foam layer 56 may have a thickness 66. In an embodiment, the thicknesses 62, 64, 66 may be in a range of, for example, 0.001 inches to 1.0 inch. In an embodiment, the thicknesses 62, 64, 66 may be identical. In an embodiment, the thicknesses 62, 64, 66 may be different. In a preferred embodiment, the thickness 62 of the foam layer 52 may be 0.05-0.15 inches; the thickness 64 of the foam layer 54 may be 0.05-0.15 inches; and the thickness 66 of the foam layer 56 may be 0.05-0.15 inches. An interface layer 58 may be between the foam layer 52 and the foam layer 54. An interface layer 60 may be between the foam layer 54 and the foam layer 56. The interface layers 58, 60 may be formed in a manner similar to the process for formulating the interface layer 8. The components for the foam layers 52, 54, 56 may be selected wherein the interface layers 58, 60 may have a moisture/vapor transmission rate necessary for healing of a specific type of wound. In a preferred embodiment, the moisture/vapor transmission rate may be 1000 g/M2/24 hours. Moreover, the interface layers 8, 58, 60 may have a thickness 9, 70, 72, respectively, which may be in a range from, for example, 0.0005 inches to 0.010 inches. In an embodiment, the thicknesses 9, 70, 72 may be identical. In an embodiment, the thicknesses 9, 70, 72 may be different. In a preferred embodiment, the thickness 70 may be less than 0.002 inches and the thickness 72 may be less than 0.002 inches.

Table 2 provides ranges for various properties demonstrated by embodiments of the dressings 2, 50:

TABLE 2

| Property | Range |
|---|---|
| Moisture/Vapor Transmission Rate | 0 to 3000 grams/M²/24 hours |
| Absorption rate | 0.1 second to >10 minutes/0.2 ml |
| Liquid absorption | 0 to 20 grams/gram of sample |
| Liquid absorption under pressure | 0 to 10 grams/gram of sample |

The properties listed in Table 2 indicate that the dressings 2, 50 may assist in wound healing, provide painfree dressing changes, absorb body fluids, impart low surface coefficient of friction, and prevent infection.

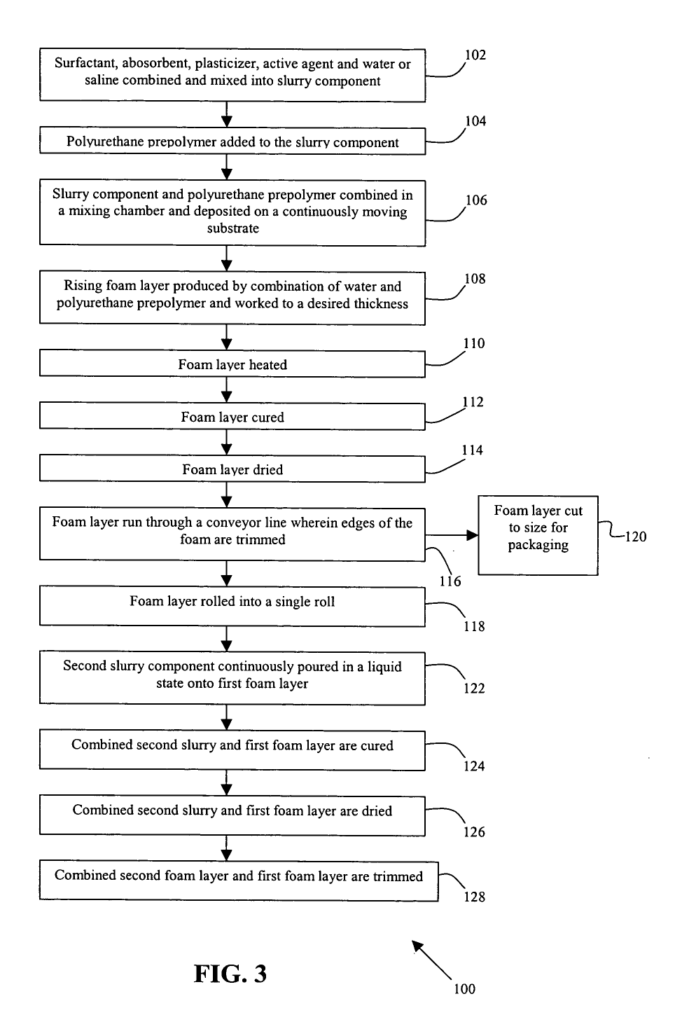

FIG. 3 illustrates a method 100 by which the dressings 2, 50 may be formed. In a first step 102, the surfactant, absorbent, plasticizer, active agent, and water or saline may be combined and mixed into a slurry component. The polyurethane prepolymer may then be added to the slurry, as shown at step 104. In an embodiment, the slurry and the polyurethane prepolymer may be combined in a mixing chamber of, for example, a high-speed mixer. The slurry and prepolymer combination may be deposited on a continuously moving substrate as a uniform viscous liquid, as shown at step 106. The water and the polyurethane prepolymer may react exothermically and may generate carbon dioxide. A rising foam layer may be produced which may be worked to a desired thickness, as shown at step 108. Thickness and/or a moisture/vapor transmission rate may be determined by compression rolling the foam layer after the rising foam layer has ceased, but before the foam layer is dried and/or cured.

The foam layer may then be heated wherein a temperature of the foam layer is raised, as shown at step 110. In an embodiment, the temperature of the foam layer is raised to a temperature in a range from 75 to 95 degrees Fahrenheit. The heating of the foam layer may be performed for approximately one to five minutes. Next, the foam layer may be cured, as shown at step 112. The curing may occur at, for example, room temperature. Curing may occur for approximately five to ten minutes. The foam layer may then be dried, as shown at step 114. The foam layer may then be placed, for example, through a conveyor line wherein edges of the foam may be trimmed, as shown at step 116. The foam layer may then be rolled into a single roll of, for example, several hundred feet, as shown at step 118.

In an alternate embodiment, the foam layer may be cut to a desired size for packaging, as shown at step 120. The desired size may be dependent on a use for the foam layer, such as, for example, a bandage for a wound, or a sheet sized wherein dressings may be cut from the sheet. A second slurry component may be continuously poured in a liquid state onto the first foam layer, as shown at step 122. The second slurry component may be poured to achieve a predetermined thickness. The combined second slurry and the first foam layer may then be cured, as shown at step 124. The curing may occur at, for example, room temperature. Curing may occur for approximately five to ten minutes. The combined second slurry and the first foam layer may then be dried, as shown at step 126. As a result, a second foam layer may be formed from the slurry and may be secured to the first foam layer at an interface layer. The combined second foam layer and the first foam layer may then be trimmed, as shown at step 128.

In an alternate embodiment, the combined second foam layer and the first foam layer may be packaged for shipping, storage, or other use. Additional foam layers may be added to the second foam layer or to the first foam layer via slurries which are poured onto the first foam layer or second foam layer. A combination of the first foam layer, second foam layer, and slurry may be cured and/or dried and/or trimmed. The additional foam layers may provide additional properties, including, for example, a desired moisture/vapor transmission rate, a desired absorption rate, a padding for the dressing, or the like, which may assist in treating a wound.

Formation of the interface layer between two foam layers may be a function of porosity, fluidity, and material set-up time. For example, if a first foam layer is porous, namely, having a pore size greater than 0.05 inches, a slurry poured onto the first foam layer may penetrate the pores rather than form a film. If the first foam layer has a pore size of 0.001 inches to 0.04 inches, the slurry may not penetrate the first foam layer, enabling the interface layer to form between the first foam layer and the slurry. Other variables during preparation of the dressing may include heat, moisture, temperature, line speed, mixing ratio, component temperatures, flow rates, mixer speed, foam thickness, foam properties and/or appearance.

Provided below, in Example 1, are results obtained from an embodiment of a foam layer:

EXAMPLE 1

| Component | Brand | % Amount |
|---|---|---|
| Surfactant | BASF Pluronic F108 | 5.7 |
| Prepolymer | LMI Prepol | 50 |
| Absorbent 1 | GPC A220 | 2.9 |
| Absorbent 2 | Aqualon CMC | 1.4 |
| Plasticizer | Dow Propylene Glycol | 5.7 |
| Water | Distilled | 34.3 |

To prepare the foam layer of Example 1, two grams of surfactant may be dissolved in twelve grams of water. Two grams of propylene glycol may be added to the water and surfactant solution. The combination may then be mixed. Next, one gram of the A220 absorbent may be added and the combination may be mixed until uniform. CMC absorbent may be added in an amount of 0.5 grams. The combination may be mixed until uniform, namely, no separation between components. The combination may then be allowed to vent any emitted gases for approximately one hour. Next, 17.5 grams of Prepol, or polyurethane prepolymer, may be added and mixed for approximately thirty seconds. The combination may then be poured onto a foam layer and covered with a release-coated liner. The foam layer may then be compressed to a desired thickness, such as, for example, 0.1 to 0.3 inches. The cover sheet may then be removed when the foam layer is tack-free.

In an embodiment, the first foam layer and the second foam layer may be constructed from components (i.e., surfactants, plasticizers, etc.) which may allow either the first foam layer or the second foam layer to contact a wound to assist in a healing process. For example, the surface 5 of the foam layer 4 may be applied to a wound. Conversely, the surface 11 of the foam layer 6 may be applied to the wound. The moisture/vapor transmission rate for the interface layer 8 may enable healing of the wound independent of whether the surface 5 or the surface 11 contacts the wound.

The dressings 2, 50 may allow oxygen, carbon dioxide and water vapor to enter and exit a wound. The interface layer(s) may provide controlled permeability (i.e., impermeable, semipermeable to permeable dressing) and may also provide increased tensile strength to the dressing 2, 50. In an embodiment, one or more of the foam layers may contain agents that absorb odors, such as, for example, activated carbon. In another embodiment, one or more of the foam layers may have agents, such as, for example, dyes, or pH indicators, which may cause the foam layer(s) to change colors.

The dressings 2, 50 may be constructed without, for example, adhesives having attached films, or other bonding materials and substrates, or lamination steps. In an embodiment, a film layer may be pre-attached to a foam layer prior to pouring of a slurry onto the foam layer. Accordingly, the dressing may be created on a single processing line. Moreover, the method 100 does not require bonding with adhesive or excessive heat. As a result, the dressing may be less expensive to manufacture than known dressings which require additional adhesives and steps to form bonds between layers.

It should be understood that various changes and modifications to the presently preferred embodiments described herein will be apparent to those skilled in the art. Such changes and modifications may be made without departing from the spirit and scope of the present invention and without diminishing its attendant advantages. It is, therefore, intended that such changes and modifications be covered by the appended claims.

1. A foam-layered dressing prepared by a process comprising the steps of:
(a) providing a first foam layer;
(b) adding a slurry over the first foam layer wherein the slurry comprises a surfactant, an absorbent, a plasticizer and an active agent;
(c) curing the slurry and the first foam layer; and
(d) drying the slurry and the first foam layer until the slurry forms a second foam layer which attaches to the first foam layer.

2. The foam-layered dressing of claim 1 further comprising:
an interface between the first foam layer and the second foam layer.

3. The foam-layered dressing of claim 1 wherein the first foam layer is comprised of a surfactant, an absorbent, a plasticizer and an active agent wherein each is identical to the surfactant, the absorbent, the plasticizer and the active agent of the slurry.

4. The foam-layered dressing of claim 1 wherein the first foam layer is comprised of a surfactant, an absorbent, a plasticizer and an active agent wherein at least one of the surfactant, the absorbent, the plasticizer and the active agent of the first foam layer is different from the surfactant, the absorbent, the plasticizer and the active agent of the slurry.

5. The foam-layered dressing of claim 1 wherein the slurry has a prepolymer.

6. The foam-layered dressing of claim 1 wherein the slurry has a saline solution.

7. A foam layer composition produced by a process comprising the steps of:
(a) providing a first slurry comprising a surfactant, an absorbent, a plasticizer and an active agent;
(b) curing the first slurry until the first slurry forms a first foam layer;
(c) adding a second slurry over the first foam layer wherein the slurry comprises a surfactant, an absorbent, a plasticizer and an active agent;
(d) curing the second slurry and the first foam layer; and
(e) drying the second slurry and the first foam layer until the second slurry forms a second foam layer is formed wherein the second foam layer bonds with the first foam layer.

8. The foam layer composition of claim 7 wherein the first foam layer and the second foam layer have different rates of moisture/vapor transmission.

9. The foam layer composition of claim 7 wherein at least one of the surfactant, the absorbent, the plasticizer and the active agent of the first foam layer is different from the surfactant, the absorbent, the plasticizer and the active agent of the second slurry.

10. The foam layer composition of claim 7 further comprising:
an interface formed between the first foam layer and the second foam layer.

11. The foam layer composition of claim 7 further comprising:
a third slurry contacting the second foam layer wherein the third slurry is comprised of a surfactant, an absorbent, a plasticizer and an active agent.

12. A foam-layered dressing prepared by a process comprising the steps of:
(a) providing a first foam layer having a first moisture/vapor transmission rate;
(b) adding a slurry over the first foam layer wherein the slurry comprises a surfactant, an absorbent, a plasticizer, an active agent and a prepolymer;
(c) curing the slurry and the first foam layer; and
(d) drying the slurry and the first foam layer until the slurry forms a second foam layer wherein the second foam layer has a second moisture/vapor transmission rate which is different from the first moisture/vapor transmission rate and further wherein an interface is formed between the first foam layer and the second foam layer wherein the interface has a third moisture/vapor transmission rate which is not equal to the first moisture/vapor transmission rate and the second moisture/vapor transmission rate.

13. The foam-layered dressing of claim 12 wherein the first foam layer is thicker than the second foam layer.

14. The foam-layered dressing of claim 12 wherein the first foam layer is hydrophilic.

15. The foam-layered dressing of claim 12 wherein the second foam layer is hydrophobic.

16. The foam-layered dressing of claim 12 wherein the first foam layer is comprised of a surfactant, an absorbent, a plasticizer and an active agent wherein each is identical to the surfactant, the absorbent, the plasticizer and the active agent of the slurry.

17. A method for making a dressing, the method comprising the steps of:
providing a first foam layer;
adding a slurry onto the first foam layer wherein the slurry comprises a surfactant, an absorbent, a plasticizer, and an active agent; and
curing the slurry and the first foam layer wherein the slurry forms a second foam layer and further wherein the second foam layer secures to the first foam layer.

18. The method of claim 17 further comprising the step of:
drying the second foam layer and the first foam layer.

19. The method of claim 17 further comprising the step of:
trimming the first foam layer and the second foam layer.

20. The method of claim 17 further comprising the step of:
mixing a prepolymer into the slurry prior to pouring the slurry onto the first foam layer.

21. The method of claim 17 further comprising the step of:
pouring a second slurry onto the second foam layer.

22. A foam composition comprising:
a surfactant in a percentage weight range from 0.1 to 20%;
an absorbent in a percentage weight range from 0.1 to 20%;
a plasticizer in a percentage weight range from 0.1 to 20%;
an active agent in a percentage weight range from 0.01 to 10%; and
a prepolymer in a percentage weight range from 30 to 70%.

23. The foam composition of claim 22 wherein the surfactant is selected from a group consisting of pluronic surfactant, F108, F88 and F68LF.

24. The foam composition of claim 22 wherein the prepolymer is selected from a group consisting of TDI, MDI, IPDI.

25. The foam composition of claim 22 wherein the plasticizer is selected from a group consisting of glycerin, propylene glycol, and castor oil.

26. The foam composition of claim 22 wherein the active agent is selected from a group consisting of white gold, silver, tea tree oil, zinc gluconate, tumeric, bromelain, lavendar, gotu kola, sodium hyaluronate, emu oil and aloe.

27. A method for applying a dressing, the method comprising the steps of:
providing a first foam layer comprising a surfactant, an absorbent, a plasticizer and an active agent wherein the first foam layer has a top surface and a bottom surface; and
securing a second foam layer to the first foam layer wherein the second foam layer comprises a surfactant, an absorbent, a plasticizer and an active agent and wherein a top surface of the second foam layer contacts a bottom surface of the first foam layer wherein either the top surface of the first foam layer or bottom surface of the second foam layer is capable of providing treatment to the wound wherein the wound undergoes a healing process when the top surface or the bottom surface contacts the wound.

28. The method of claim 27 further comprising the step of:
contacting the wound with the top surface of the first foam layer.

29. The method of claim 27 further comprising the step of:
contacting the wound with the bottom surface of the second foam layer.

30. A method for making a dressing, the method comprising the steps of:
providing a first foam layer having a film layer attached to the first foam layer;
adding a slurry onto the first foam layer wherein the slurry comprises a surfactant, an absorbent, a plasticizer, and an active agent; and
curing the slurry and the first foam layer wherein the slurry forms a second foam layer and further wherein the second foam layer secures to the first foam layer.

31. The method of claim 30 further comprising the step of:
drying the second foam layer and the first foam layer.

32. The method of claim 30 further comprising the step of:
trimming the first foam layer and the second foam layer.

33. The method of claim 30 wherein the film layer is constructed from a copolymer film.

34. The method of claim 30 wherein the first foam layer is hydrophobic.
